(19) United States
(12) Patent Application Publication
(10) Pub. No.: US 2025/0037190 A1
(43) Pub. Date: Jan. 30, 2025

(54) INFORMATION DISPLAY DEVICE, INFORMATION DISPLAY METHOD, AND STORAGE MEDIUM

(71) Applicant: NEC Corporation, Tokyo (JP)

(72) Inventors: Kei SHIBUKAWA, Tokyo (JP); Yuto Nakaya, Tokyo (JP); Naru Otsuka, Tokyo (JP)

(73) Assignee: NEC Corporation, Tokyo (JP)

(21) Appl. No.: 18/770,461

(22) Filed: Jul. 11, 2024

(30) Foreign Application Priority Data
Jul. 26, 2023 (JP) 2023-12368

(51) Int. Cl. G06Q 30/0601

(52) U.S. Cl. CPC G06Q 30/0641; G06Q 30/0631

(57) ABSTRACT

An information display device of the present disclosure includes an acquisition means for acquiring posted information of a product posted on a media, a reception means for receiving specification information specifying a posting media on which a product to be searched is posted, a specification means for specifying, based on the posted information and the specification information, a specific product posted on the posting media and a candidate product posted on a similar media similar to the posting media, and a display means for displaying information of the specific product and information of the candidate product.

This application is based upon and claims the benefit of priority from Japanese Patent Application No. 2023-121368, filed on Jul. 26, 2023, the disclosure of which is incorporated herein in its entirety by reference.

### TECHNICAL FIELD

The present disclosure relates to an information display device, an information display method, and a storage medium.

### BACKGROUND ART

When a customer visits a store for a product posted on a media such as a television program, the customer or a store clerk searches for the product using a terminal provided in the store.

For example, JP 2003-233751 A discloses a technique in which, during viewing of a broadcast program or the like, when a customer who has selected a desired product introduced therein and visits a store inputs an information request of the selected product, a position of the product in the store, a detailed description of the product, and the like are displayed on a display device from a product database.

An example of objects of the present disclosure is to provide an information display device capable of finding a desired product even if the user does not accurately remember product posted information.

### SUMMARY

An information display device according to an aspect of the present disclosure includes an acquisition means for acquiring posted information of a product posted on a media, a reception means for receiving specification information specifying a posting media on which a product to be searched is posted, a specification means for specifying, based on the posted information and the specification information, a specific product posted on the posting media and a candidate product posted on a similar media similar to the posting media, and a display means for displaying information of the specific product and information of the candidate product.

An information display device according to an aspect of the present disclosure includes an acquisition means for acquiring posted information of a product posted on a media, a reception means for receiving specification information specifying a posting media on which a product to be searched is posted, a specification means for specifying, based on the posted information and the specification information, a specific product posted on the posting media and a candidate product posted on a similar media similar to the posting media, and a display means for displaying information of the specific product and an icon for displaying information of the candidate product.

An information display method according to an aspect of the present disclosure causing a computer to execute acquiring posted information of a product posted on a media, receiving specification information specifying a posting media on which a product to be searched is posted, specifying, based on the posted information and the specification information, a specific product posted on the posting media and a candidate product posted on a similar media similar to the posting media, and displaying information of the specific product and information of the candidate product.

A non-transitory storage medium according to an aspect of the present disclosure having stored therein a program causing a computer to execute acquiring posted information of a product posted on a media, receiving specification information specifying a posting media on which a product to be searched is posted, specifying, based on the posted information and the specification information, a specific product posted on the posting media and a candidate product posted on a similar media similar to the posting media, and displaying information of the specific product and information of the candidate product.

### BRIEF DESCRIPTION OF THE DRAWINGS

Exemplary features and advantages of the present invention will become apparent from the following detailed description when taken with the accompanying drawings in which:

FIG. 1 is a functional block diagram illustrating an example of an information display device according to the present disclosure;

FIG. 2 is a diagram illustrating a hardware configuration in which the information display device according to the present disclosure is implemented by a computer device and its peripheral devices;

FIG. 3 is a display example of information of a specific product and information of a candidate product in the present disclosure;

FIG. 4 is a flowchart illustrating an operation of information display in the present disclosure;

FIG. 5A is a display example of the information of the specific product and icons for displaying the information of the candidate product in the present disclosure;

FIG. 5B is a display example of the information of the candidate product in the present disclosure;

FIG. 6 is a functional block diagram illustrating an example of the information display device according to the present disclosure;

FIG. 7 is a display example of a list of related products in the present disclosure;

FIG. 8 is a flowchart illustrating an operation of information display in the present disclosure;

FIG. 9 is a functional block diagram illustrating an example of the information display device according to the present disclosure; and

FIG. 10 is a flowchart illustrating an operation of information display in the present disclosure.

### EXAMPLE EMBODIMENT

Hereinafter, example embodiments of an information display device, an information display method, a program, and a non-transitory storage medium recording the program according to the present disclosure will be described in detail with reference to the drawings. The present example embodiments do not limit the disclosed technology.

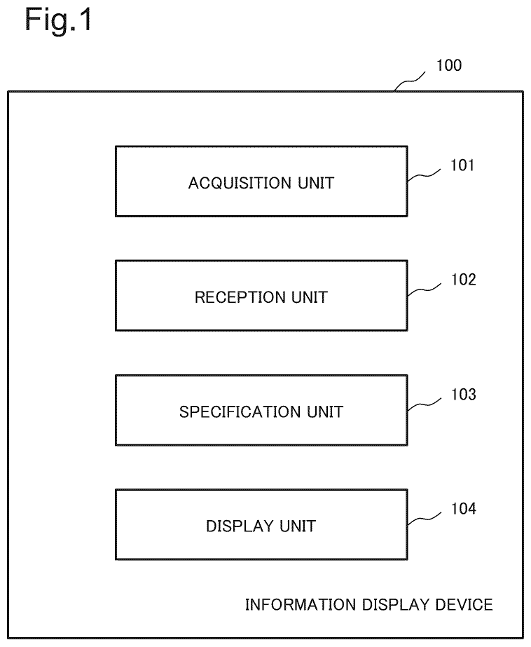

FIG. 1 is a functional block diagram illustrating an example of an information display device 100 according to the present disclosure. As illustrated in FIG. 1, the information display device 100 includes an acquisition unit 101, a reception unit 102, a specification unit 103, and a display unit 104.

The information display device 100 specifies a product in a store that a customer has purchased from among products picked up by media, and displays information of the product. The store is, for example, a retail store in which a customer purchases a product displayed on a shelf. Examples of the retail store include a bookstore, a department store, a supermarket, a convenience store, an electric appliance store, a home appliance store, a specialty store such as a drug store, and the like, and the business form is not limited.

The information display device 100 displays information of a specified product on a display device such as a signage provided in a store, a terminal device possessed by a customer or a store clerk, or the like. In these display devices or terminal devices, for example, an application program for searching for product information posted on a media is installed. In the present specification, it is mainly assumed that a customer performs an operation for searching for a product, but a store clerk of the store may perform an operation for searching instead of the customer.

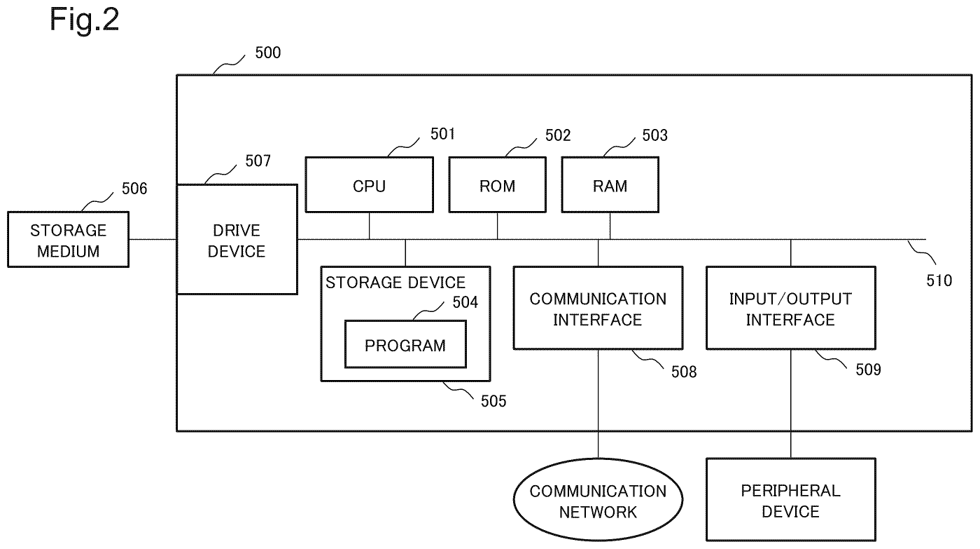

FIG. 2 is a diagram illustrating an example of a hardware configuration in which the information display device 100 in the present disclosure is achieved by a computer device 500 including a processor. As illustrated in FIG. 2, the information display device 100 includes a memory such as a central processing unit (CPU) 501, a read only memory (ROM) 502, and a random access memory (RAM) 503, a storage device 505 such as a hard disk that stores a program 504, a communication interface 508 for network connection, and an input/output interface 509 that inputs and outputs data. In the present disclosure, the storage device 505 stores a media name and information of a product posted on the media in association with each other.

In the first example embodiment, the components in the information display device 100 are connected via a bus 510, for example. The information display device 100 illustrated in FIG. 1 can also be configured by cloud computing or the like.

The CPU 501 operates the operating system to control the entire information display device 100 according to the first example embodiment of the present disclosure.

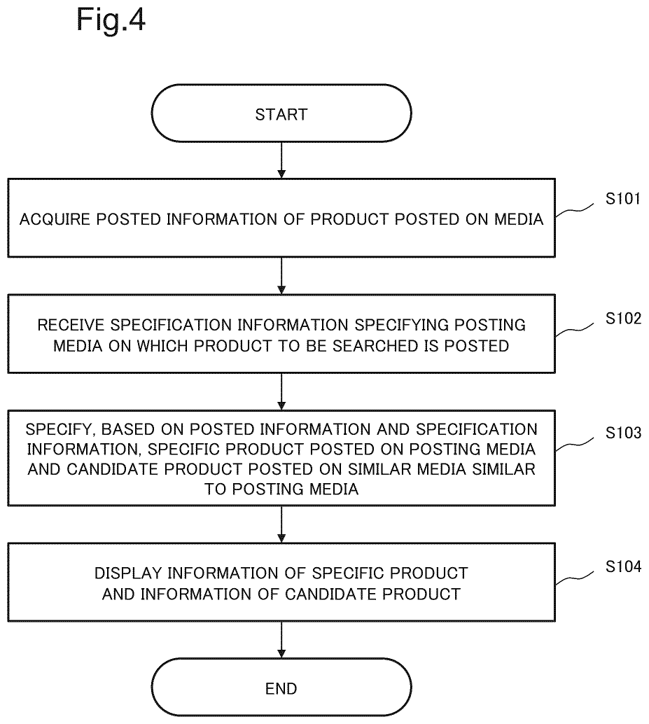

The CPU 501 reads a program and data from a storage medium 506 mounted on, for example, a drive device 507 to a memory. The CPU 501 functions as the acquisition unit 101, the reception unit 102, the specification unit 103, the display unit 104, and a part thereof in the present disclosure, and executes processing or commands in the flowchart illustrated in FIG. 4 to be described later based on a program.

The storage medium 506 is, for example, an optical disk, a flexible disk, a magnetic optical disk, an external hard disk, a semiconductor memory, or the like. A semiconductor memory or the like which is a part of the storage medium is a non-volatile storage device, and records a program therein. The program may be downloaded from an external computer (not illustrated) connected to a communication network.

As described above, the first example embodiment illustrated in FIG. 1 is implemented by the computer hardware illustrated in FIG. 2. However, the means for implementing each unit included in the information display device 100 of FIG. 1 is not limited to the configuration described above. The information display device 100 may be implemented by one physically coupled device, or may be implemented by a plurality of devices by connecting two or more physically separated devices in a wired or wireless manner. The information display device 100 may further include a display device such as a display. The information display device 100 and the display device may be configured as a system achieved by separate devices.

The acquisition unit 101 is a means for acquiring the posted information of a product posted on a media. For example, the acquisition unit 101 acquires, within a predetermined period, information of a product posted on a mass media such as a television program, the Internet including a social networking service (SNS), a newspaper, a magazine, a radio program, or a transportation advertisement posted on a public transportation vehicle or a station yard, and stores the information in the storage device 505. In the present disclosure, posting is not limited to displaying a specific product name on media, but also includes introducing information that identifies a product name or a product verbally.

Specific examples of the posted information include information that can identify media on which a product is posted, such as a media name and a posted date, a program name and a broadcast date for a television program or a radio program, a site name and a posted date for the Internet, the newspaper name and the issued date for a newspaper, and the magazine name and the issued date for a magazine. The posted information of the transportation advertisement is, for example, a posted place and a posted date.

The acquisition unit 101 acquires the posted information in each media by a known method. For example, in the case of a television program, the acquisition unit 101 acquires the posted information posted on a program site of each broadcasting station. For example, the acquisition unit 101 may acquire the posted information from an external database that has collected information of products posted on each media. For example, the acquisition unit 101 stores the product information in the storage device 505 in association with the product information posted for each combination of the media name and the posted date.

The reception unit 102 is a means for receiving specification information specifying a posting media on which a product to be searched is posted. The reception unit 102 receives specification information input via a display device such as a signage provided in a store, a terminal device possessed by a customer or a store clerk, or the like. The input specification information may be character data or voice data.

The reception unit 102 receives, as the specification information, information specifying media on which the product is posted, such as a media name with which the product is posted, a posted date and time, or a posted place. In a case where the media on which the product is posted is a television program or a radio program, the reception unit 102 receives, for example, information of the program name, the genre of the program, or the name of the person who appeared. The genre of the program is, for example, a classification such as “news/reports”, “sports”, “information/wide show”, and “variety show”. For example, in a case where the media is the Internet, the reception unit 102 receives information of a posted site name, a contributor to the SNS, or a posted uniform resource locator (URL). For example, in a case where the media is a newspaper or a magazine, the reception unit 102 receives information of a newspaper name or a magazine name and an issue date. For example, in a case where the media is a transportation advertisement, the reception unit 102 receives information of a posted place and a posted day.

In a case where the customer does not remember a media name such as a program name, a site name, a newspaper name, or a magazine name, the reception unit 102 may receive a keyword for specifying the media name. In this case, when there is a plurality of relevant media names, the reception unit 102 may display a screen for allowing the customer to select a media name.

In a case where the store handles various products, the reception unit 102 may receive the classification of the product in order to easily identify the product that the customer is looking for. The reception unit 102 receives, for example, classification of products such as food, books, and cosmetics.

The specification unit 103 is a means for specifying a specific product posted on a posting media and a candidate product posted on a similar media similar to the posting media based on the posted information and the specification information. For example, the specification unit 103 accesses the storage device 505, specifies the posting media using the specification information received by the reception unit 102 as a search key, and acquires information of the specific product posted on the specified media.

The specification unit 103 specifies a candidate product posted on a media similar to the posting media. If the media is a television program or a radio program, the similar media is a program of a similar genre broadcasted in the same time zone, or a program of the same program with a different broadcasting date. If the media is a magazine or a newspaper, the media is a media that is the same genre and is released at the same time, or a media that is the same media and has different release dates. If the media is the Internet, the media is a site browsed by a predetermined ratio or more of persons having a specific attribute or hobby. A transportation advertisement is an advertisement posted in the same area.

The specification unit 103 may specify, as a similar media, a media that has been mistaken for the posting media a predetermined number of times or more in the past. For example, the number of times of mistakes is stored in the storage device 505, and in a case where the product that the customer has been searching for is not a specific product posted on the posting media but a candidate product posted on a similar media, the number of times the posting media has been mistaken for the similar media is counted. Although the example of the similar media has been described above, the above-described example is an example of the similar media, and is not limited thereto as long as it is a media that may be confused and stored by a customer.

The display unit 104 is a means for displaying the information of the specific product and the information of the candidate product. The display unit 104 displays the information of the specific product specified by the specification unit 103 and the information of the candidate product together with the media name in which the products are posted. For example, the display unit 104 displays the information of the specific product and the information of the candidate product on the display device or the terminal device that has received the specification information.

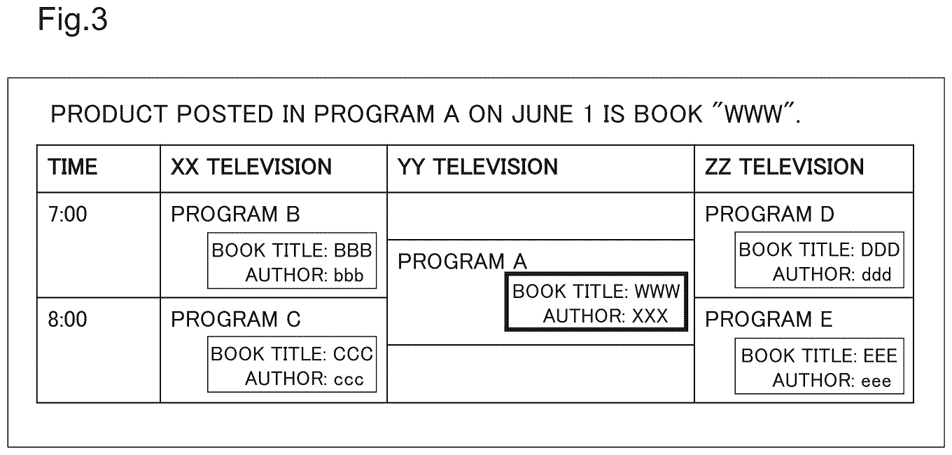

Here, an example of a display screen on which the display unit 104 displays a product search result will be described with reference to the drawing. In the drawing, a case where the product is a book is taken as an example. FIG. 3 is an example of displaying information of a specific product and information of a candidate product in the present disclosure. The example of FIG. 3 is an example in a case where the media is a television program, and is a display example when a product posted on program A on Jun. 1, 2023 is searched. As illustrated in FIG. 3, in a case where the book title “WWW” posted on “program A” of a YY television is the specific product, a book “BBB” posted on a television program “program B” of an XX television of the same genre in the same time zone, a book “CCC” posted on “program C”, a book “DDD” posted on “program D” of a ZZ television, and a book “EEE” posted on “program E” are displayed together as candidate products. The display unit 104 may display the specific product in a mode distinguishable from the candidate product so that the specific product can be grasped. In the example of FIG. 3, a frame surrounding the information of the specific product is emphasized by a thick line.

The operation of the information display device 100 configured as described above will be described with reference to the flowchart of FIG. 4.

FIG. 4 is a flowchart illustrating an outline of the operation of information display device 100 according to the present disclosure. The processing according to this flowchart may be executed based on program control by the processor described above.

As illustrated in FIG. 4, first, the acquisition unit 101 acquires the posted information of a product posted on a media (step S101). Next, the reception unit 102 receives specification information for specifying a posting media on which the product to be searched is posted (step S102). Next, the specification unit 103 specifies the specific product posted on the posting media and the candidate product posted on a similar media similar to the posting media based on the posted information and the specification information (step S103). Finally, the display unit 104 displays the information of the specific product and the information of the candidate product (step S104). Thus, the information display device 100 ends the operation.

In the present example embodiment, the specification unit 103 specifies the specific product posted on the posting media and the candidate product posted on a similar media similar to the posting media based on the posted information and the specification information. Then, the display unit 104 displays the information of the specific product and the information of the candidate product. In this case, even if the specific product is not the product that the customer is looking for, checking the candidate product increases the possibility of finding a desired product. Therefore, even if the posted information of the product is not accurately remembered, it is possible to find a desired product.

### [Modification 1]

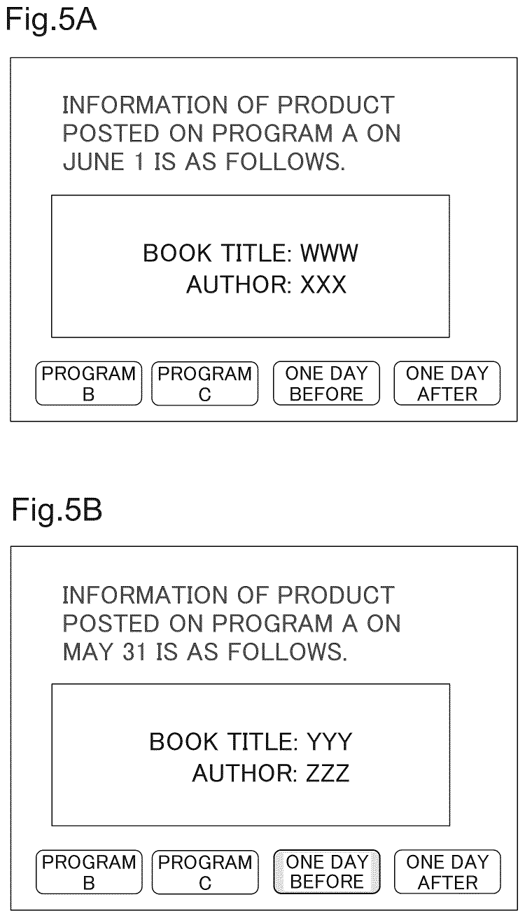

Next, a modification of the present disclosure will be described in detail with reference to the drawings. In the first example embodiment, the display unit 104 displays the information of the specific product and the information of the candidate product. On the other hand, in the modification, the display unit 104 displays the information of the specific product and icons for displaying the information of the candidate product. FIGS. 5A and 5B are diagrams for explaining a display mode of the information of a specific product and the icons for displaying the information of a candidate product in the present disclosure. FIG. 5A is an example in which the information of the specific product and the icons for displaying the information of the candidate product are displayed, and FIG. 5B is a display example of the information of the candidate product.

The example of FIG. 5A illustrates a display example when a product posted on program A is searched on June 1 as in FIG. 3. In FIG. 5A, the information of the specific product and icons “program B”, “program C”, “one day before”, and “one day after” as the icons for displaying the information of the candidate product are displayed. In FIG. 5A, the icons of “program B” and “program C” are icons for displaying products posted in programs of the same genre that are broadcast in the same time zone as “program A”. In FIG. 5A, the icons of “one day before” and “one day after” are icons for displaying products posted in “program A” one day before and one day after June 1, respectively.

The example of FIG. 5B illustrates a display example in a case where the icon of “one day before” is selected in FIG. 5A. As illustrated in FIG. 5B, information of a product posted on program A on May 31, which is one day before June 1, is displayed.

In the present modification, the display unit 104 displays the information of the specific product and the icons for displaying the information of the candidate product. As a result, only the information of the candidate product relevant to the icon selected by the customer is displayed, so that the product information can be easily viewed.

### [Modification 2]

Next, a modification of the present disclosure will be described in detail with reference to the drawings. Hereinafter, description of contents overlapping with the above description will be omitted to the extent that the description of the present example embodiment is not unclear. Similarly to the computer device illustrated in FIG. 2, each component in each example embodiment of the present disclosure can be achieved not only by hardware but also by a computer device or software based on program control.

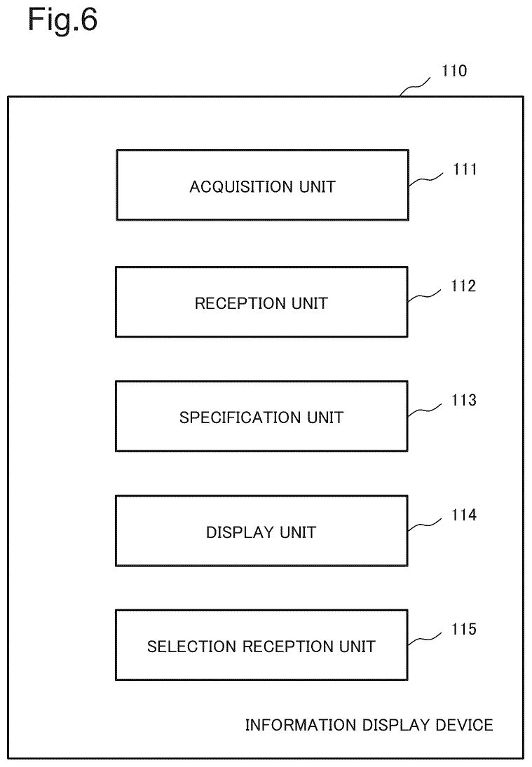

FIG. 6 is a functional block diagram illustrating an example of an information display device 110 according to the present disclosure. With reference to FIG. 6, the information display device 110 according to a second example embodiment will be described focusing on a portion different from the information display device 100 according to the first example embodiment.

The information display device 110 includes an acquisition unit 111, a reception unit 112, a specification unit 113, a display unit 114, and a selection reception unit 115. The acquisition unit 111, the reception unit 112, and the specification unit 113 have the same configurations and functions as the relevant components in the first example embodiment.

The selection reception unit 115 is a means for receiving selection of at least one product from among the specific product and the candidate product. In the present modification, in the display screen displayed by the display unit 114, an area in which the information of the specific product and the information of each candidate product are displayed may be selectively displayed. Then, the selection reception unit 115 receives an operation in which the customer selects one of the specific product and the candidate product on the display screen, and outputs the information of the selected product to the display unit 114. The selection reception unit 115 may receive information of a product selected by the customer inputting character or voice.

The display unit 114 displays information of any selected product in addition to the function of the display unit 104. The display unit 114 displays contributing information of the SNS, posted information of the media, or a display position in a store as the information regarding the product. The display unit 114 may display the contributing information by a famous person or the number of times of contributing the product information as the contributing information of the SNS. The display unit 114 may display a characteristic of the product, a comment uttered by a cast of the media about the product, or the like, as the posted information of the media.

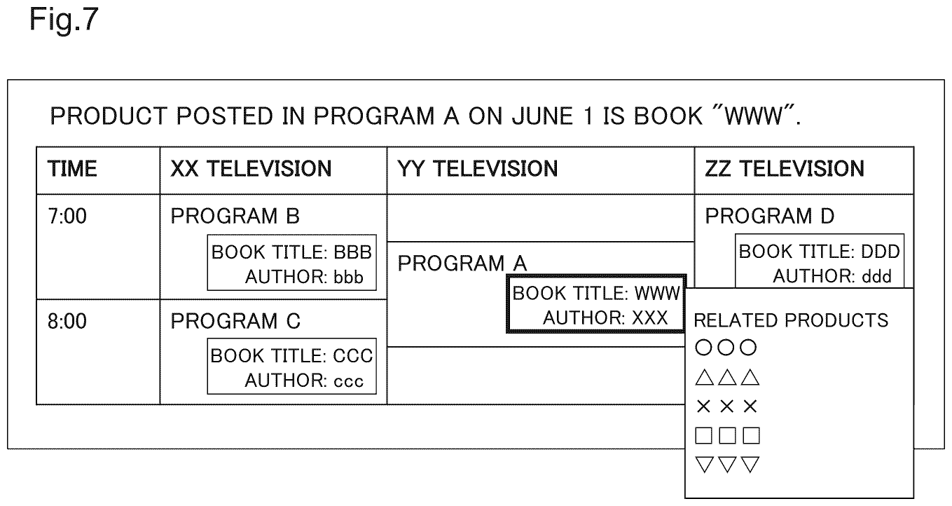

The display unit 114 may display a list of related products related to the selected product. FIG. 7 is a display example of a list of related products in the present disclosure. The example of FIG. 7 illustrates a case where the book “WWW” that is the specific product is selected. In this case, as illustrated in FIG. 7, the display unit 114 displays a list of related products associated with “WWW”, next to the book “WWW”. Examples of the related product include, in a case where the product is a book, a book of the same genre, a book that has been simultaneously purchased a predetermined number of times, and the like, but are not limited thereto as long as there is some relevance with the selected specific product or candidate product.

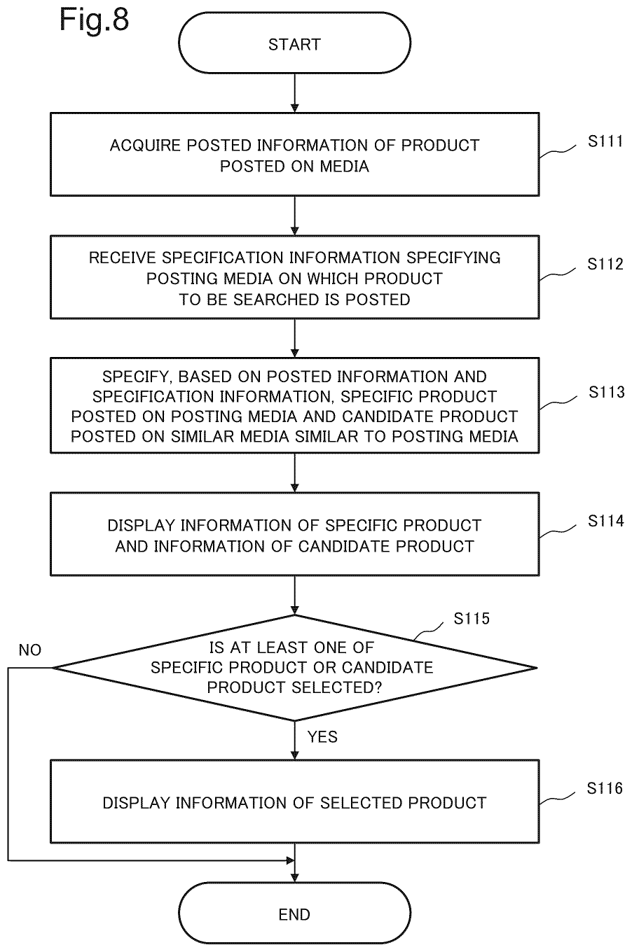

The operation of the information display device 110 configured as described above will be described with reference to the flowchart of FIG. 8.

FIG. 8 is a flowchart illustrating an outline of the operation of information display device 110 according to the present disclosure. The processing according to this flowchart may be executed based on program control by the processor described above.

As illustrated in FIG. 8, first, the acquisition unit 111 acquires the posted information of a product posted on a media (step S111). Next, the reception unit 112 receives specification information for specifying a posting media on which the product to be searched is posted (step S112). Next, the specification unit 113 specifies the specific product posted on the posting media and the candidate product posted on a similar media similar to the posting media based on the posted information and the specification information (step S113). Next, the display unit 114 displays the information of the specific product and the information of the candidate product (step S114). Next, in a case where the selection reception unit 115 receives that at least one of the specific product or the candidate product has been selected (S115; YES), the display unit 114 displays information of the selected product (step S116). On the other hand, in a case where the selection reception unit 115 does not receive that at least one of the specific product or the candidate product has been selected (S115; NO) and ends the flow. Thus, the information display device 110 ends the operation.

In the present modification, the selection reception unit 115 receives selection of at least one of the specific product or the candidate product, and the display unit 114 displays information of the selected product. As a result, it is possible to increase the possibility of purchasing the product by obtaining the information of the product selected by the customer. In the present modification, in a case where the display unit 114 displays a list of related products related to the selected product, it is possible to indicate information of a product that the customer is likely to purchase simultaneously with the product.

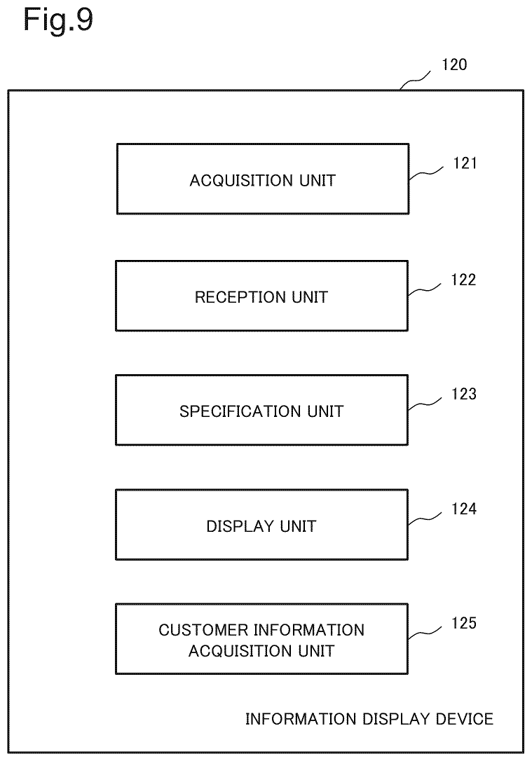

FIG. 9 is a functional block diagram illustrating an example of an information display device 120 according to the present disclosure. With reference to FIG. 9, the information display device 120 will be described focusing on portions different from the information display device 100 and the information display device 110.

The information display device 120 includes an acquisition unit 121, a reception unit 122, a specification unit 123, a display unit 124, and a customer information acquisition unit 125. The acquisition unit 121 and the reception unit 122 have the same configuration and function as the relevant components in the information display device 100 or the information display device 110.

The customer information acquisition unit 125 is a means for acquiring preference information regarding the preference of the customer. The preference information is a customer's preference tendency such as food and entertainment estimated based on at least one of attribute information such as gender or age of the customer and purchase history information. The customer information acquisition unit 125 acquires preference information by a known method. For example, the customer information acquisition unit 125 acquires the attribute information of the customer by analyzing an image obtained by capturing the appearance of the customer with a camera. The camera is provided in, for example, a display device or a terminal device that searches for a specific product. For example, the customer information acquisition unit 125 acquires the purchase history information including the information of the product purchased by the customer from the terminal device paid by the customer at the time of purchase of the product. The customer information acquisition unit 125 outputs the acquired preference information of the customer to the specification unit 123.

In addition to the function of the specification unit 103, the specification unit 123 specifies a recommended product from among products posted on a specified media and a similar media based on preference information. For example, the specification unit 123 specifies, as a recommended product, a product that is the same as or similar to a product purchased by the customer a predetermined number of times or more. In a case where the product is a book, the similar product is, for example, a book written by the same author or an author whose style is similar. However, as a method of specifying the recommended product by the specification unit 123, various known methods can be used, and the method is not limited to the above example as long as the method is a method of specifying a product that a customer can purchase.

The display unit 124 displays information of the recommended product specified by the specification unit 123. The information displayed as the information regarding the recommended product by the display unit 124 is similar to the information regarding the specific product or the candidate product, and is, for example, the contributing information of an SNS, the posted information of a media, or a display position in a store.

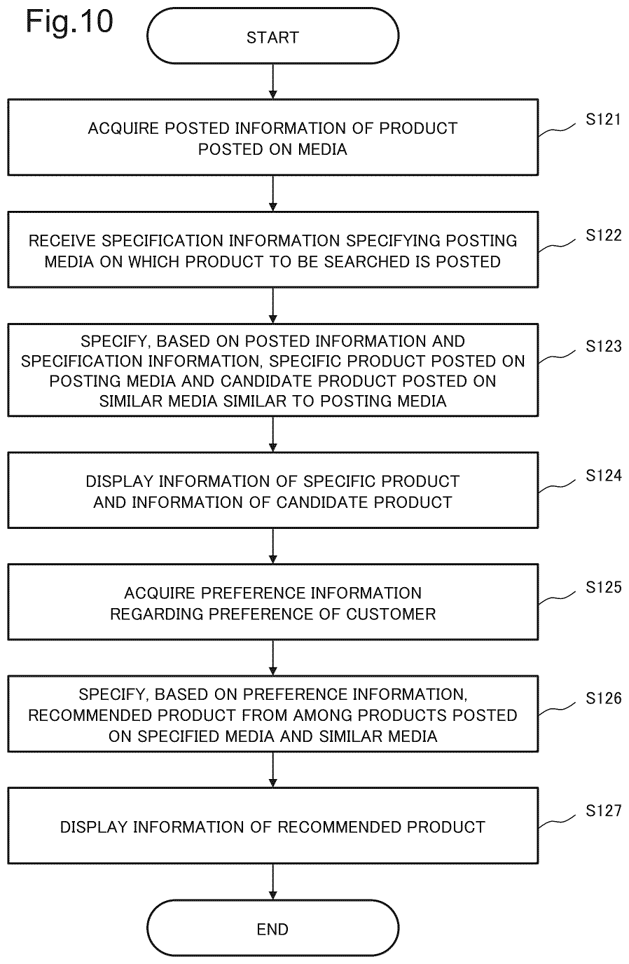

FIG. 10 is a flowchart illustrating an outline of the operation of the information display device 120 in the present disclosure. The processing according to this flowchart may be executed based on program control by the processor described above.

As illustrated in FIG. 10, first, the acquisition unit 121 acquires the posted information of a product posted on a media (step S121). Next, the reception unit 122 receives specification information for specifying a posting media on which the product to be searched is posted (step S122). Next, the specification unit 123 specifies the specific product posted on the posting media and the candidate product posted on a similar media similar to the posting media based on the posted information and the specification information (step S123). Next, the display unit 124 displays the information of the specific product and the information of the candidate product (step S124). Next, the customer information acquisition unit 125 acquires preference information regarding the preference of the customer (step S125). Next, the specification unit 123 specifies a recommended product from among products posted on the specified media and the similar media based on the preference information (step S126). Finally, the display unit 124 displays the information of the recommended product (step S127). Thus, the information display device 120 ends the operation.

In the present modification, the specification unit 123 specifies a recommended product from among products posted on a specified media and a similar media based on preference information, and the display unit 124 displays the information of the recommended product. As a result, it is possible to indicate the product information by narrowing down the products that the customer may purchase.

Although the present disclosure has been particularly shown and described with reference to the present example embodiment, the present disclosure is not limited to the above example embodiment and the modifications. It will be understood by those of ordinary skill in the art that various changes in form and details may be made therein without departing from the spirit and scope of the present disclosure as defined by the claims. Each of the above-described modifications can be combined. For example, in Modification 2 and Modification 3, the display units 114 and 124 may display icons for displaying the information of the specific product and the information of the candidate product instead of displaying the information of the specific product and the information of the candidate product.

Although the plurality of operations is described in order in the form of a flowchart, the order of description does not limit the order of executing the plurality of operations. Therefore, when each example embodiment is implemented, the order of the plurality of operations can be changed within a range that does not interfere with the content.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

In the method disclosed in JP 2003-233751 A described above, the customer may not accurately remember the information of the media name or the product viewed, and it may be difficult to find the product being searched for.

An example of effects of the present disclosure is to provide an information display device capable of finding a desired product even if the user does not accurately remember product posted information.

Some or all of the above example embodiments may be described as the following Supplementary Notes, but are not limited to the following.

### (Supplementary Note 1)

An information display device including:
an acquisition means for acquiring posted information of a product posted on a media;
a reception means for receiving specification information specifying a posting media on which a product to be searched is posted;
a specification means for specifying, based on the posted information and the specification information, a specific product posted on the posting media and a candidate product posted on a similar media similar to the posting media; and
a display means for displaying information of the specific product and information of the candidate product.

### (Supplementary Note 2)

An information display device including:
an acquisition means for acquiring posted information of a product posted on a media;
a reception means for receiving specification information specifying a posting media on which a product to be searched is posted;
a specification means for specifying, based on the posted information and the specification information, a specific product posted on the posting media and a candidate product posted on a similar media similar to the posting media; and
a display means for displaying information of the specific product and an icon for displaying information of the candidate product.

### (Supplementary Note 3)

The information display device according to Supplementary Note 1, in which the display means displays the specific product and the candidate product in a distinguishable manner.

### (Supplementary Note 4)

The information display device according to Supplementary Note 1 or 2, further including
a selection reception means for receiving selection of at least one of the specific product or the candidate product, in which
the display means further displays information of the selected product.

### (Supplementary Note 5)

The information display device according to Supplementary Note 4, in which the display means displays a list of related products related to the selected product.

### (Supplementary Note 6)

The information display device according to Supplementary Note 1 or 2, in which the specification means specifies, as a similar media, a media that has been mistaken for the posting media a predetermined number of times or more in a past.

### (Supplementary Note 7)

The information display device according to Supplementary Note 1 or 2, further including
a customer information acquisition means for acquiring preference information regarding a preference of a customer, in which
the specification means further specifies a recommended product from among products posted on the posting media and the similar media based on the preference information, and
the display means displays the recommended product.

### (Supplementary Note 8)

An information display method causing a computer to execute:
acquiring posted information of a product posted on a media;
receiving specification information specifying a posting media on which a product to be searched is posted;
specifying, based on the posted information and the specification information, a specific product posted on the posting media and a candidate product posted on a similar media similar to the posting media; and
displaying information of the specific product and information of the candidate product.

### (Supplementary Note 9)

An information display method causing a computer to execute:
acquiring posted information of a product posted on a media;
receiving specification information specifying a posting media on which a product to be searched is posted;
specifying, based on the posted information and the specification information, a specific product posted on the posting media and a candidate product posted on a similar media similar to the posting media; and
displaying information of the specific product and an icon for displaying information of the candidate product.

### (Supplementary Note 10)

The information display method according to Supplementary Note 8, in which the specific product and the candidate product are displayed in a distinguishable manner in the displaying.

### (Supplementary Note 11)

The information display method according to Supplementary Note 8 or 9, further including:
receiving selection of at least one of the specific product or the candidate product, in which
information of the selected product is further displayed in the displaying.

### (Supplementary Note 12)

The information display method according to Supplementary Note 11, in which a list of related products related to the selected product is displayed in the displaying.

### (Supplementary Note 13)

The information display method according to Supplementary Note 8 or 9, in which a media that has been mistaken for the posting media a predetermined number of times or more in a past is specified as a similar media in the specifying.

### (Supplementary Note 14)

The information display method according to Supplementary Note 8 or 9, further including:
acquiring preference information regarding a preference of a customer, in which
a recommended product is further specified in the specifying from among products posted on the posting media and the similar media based on the preference information, and
the recommended product is displayed in the displaying.

### (Supplementary Note 15)

A non-transitory storage medium having stored therein a program causing a computer to execute:
acquiring posted information of a product posted on a media;
receiving specification information specifying a posting media on which a product to be searched is posted;
specifying, based on the posted information and the specification information, a specific product posted on the posting media and a candidate product posted on a similar media similar to the posting media; and
displaying information of the specific product and information of the candidate product.

### (Supplementary Note 16)

A non-transitory storage medium having stored therein a program causing a computer to execute:
acquiring posted information of a product posted on a media;
receiving specification information specifying a posting media on which a product to be searched is posted;
specifying, based on the posted information and the specification information, a specific product posted on the posting media and a candidate product posted on a similar media similar to the posting media; and
displaying information of the specific product and an icon for displaying information of the candidate product.

### (Supplementary Note 17)

The non-transitory storage medium according to Supplementary Note 15, in which the specific product and the candidate product are displayed in a distinguishable manner in the displaying.

### (Supplementary Note 18)

The non-transitory storage medium according to Supplementary Note 15 or 16, further including
receiving selection of at least one of the specific product or the candidate product, in which
information of the selected product is further displayed in the displaying.

### (Supplementary Note 19)

The non-transitory storage medium according to Supplementary Note 18, in which a list of related products related to the selected product is displayed in the displaying.

### (Supplementary Note 20)

The non-transitory storage medium according to Supplementary Note 15 or 16, in which a media that has been mistaken for the posting media a predetermined number of times or more in a past is specified as a similar media in the specifying.

### (Supplementary Note 21)

The non-transitory storage medium according to Supplementary Note 15 or 16, further including:
acquiring preference information regarding a preference of a customer, in which
a recommended product is further specified in the specifying from among products posted on the posting media and the similar media based on the preference information, and
the recommended product is displayed in the displaying.

1. An information display device comprising:
a memory storing instructions; and
at least one processor configured to execute the instructions to:
acquire posted information of a product posted on a media;
receive specification information specifying a posting media on which a product to be searched is posted;
specify, based on the posted information and the specification information, a specific product posted on the posting media and a candidate product posted on a similar media similar to the posting media; and
display information of the specific product and information of the candidate product.

2. An information display device comprising:
a memory storing instructions; and
at least one processor configured to execute the instructions to:
acquire posted information of a product posted on a media;
receive specification information specifying a posting media on which a product to be searched is posted;
specify, based on the posted information and the specification information, a specific product posted on the posting media and a candidate product posted on a similar media similar to the posting media; and
display information of the specific product and an icon for displaying information of the candidate product.

3. The information display device according to claim 1, wherein the at least one processor is further configured to execute the instructions to:
display the specific product and the candidate product in a distinguishable manner.

4. The information display device according to claim 1, the at least one processor is further configured to execute the instructions to:
receive selection of at least one of the specific product or the candidate product; and
display information of the selected product.

5. The information display device according to claim 4, the at least one processor is further configured to execute the instructions to:
display a list of related products related to the selected product.

6. The information display device according to claim 1, the at least one processor is further configured to execute the instructions to:
specify as a similar media, a media that has been mistaken for the posting media a predetermined number of times or more in a past.

7. The information display device according to claim 1, the at least one processor is further configured to execute the instructions to:
acquire preference information regarding a preference of a customer;
specify a recommended product from among products posted on the posting media and the similar media based on the preference information; and
display the recommended product.

8. An information display method causing a computer to execute:
acquiring posted information of a product posted on a media;
receiving specification information specifying a posting media on which a product to be searched is posted;
specifying, based on the posted information and the specification information, a specific product posted on the posting media and a candidate product posted on a similar media similar to the posting media; and
displaying information of the specific product and information of the candidate product.
